(19) United States
(12) Patent Application Publication
(10) Pub. No.: US 2010/0275600 A1
(43) Pub. Date: Nov. 4, 2010

(54) SYSTEM AND METHOD OF RECOVERING HEAT AND WATER AND GENERATING POWER FROM BITUMEN MINING OPERATIONS

(76) Inventors: Brian C. Speirs, Calgary (CA); James Andrew Dunn, Calgary (CA)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/679,457

(22) PCT Filed: Oct. 10, 2008
(86) PCT No.: PCT/US08/79576

§ 371 Date: Jun. 29, 2010

(30) Foreign Application Priority Data
Nov. 8, 2007 (CA) 2610052

(51) Int. Cl. F01K 23/06; C10G 1/04; C02F 1/04; B01D 3/00

(52) U.S. Cl. 60/670; 208/390; 203/10; 196/98

(57) ABSTRACT

A method recovering heat and water from a warm slurry, such as warm tailings from a oil sands extraction mining operation, is provided. The method comprises providing the tailings to a vacuum vessel, removing, from the vacuum vessel, warm vapor derived from the tailings, condensing the warm vapor in a condenser to produce water, and recovering the water from the condenser. Cool river or pond water can be warmed with the heat from the vapor for additional uses in the mining operation. Essentially pure water can be obtained in the process. This can also be achieved using one or flash vessels in series to condense the vapor. Power can also be generated from the vapor using a turbine.

### CROSS-REFERENCE TO RELATED APPLICATIONS

The application claims priority from Canadian Patent Application number 2,610,052 which was filed on 8 Nov. 2007, which is incorporated herein by reference.

### FIELD OF THE INVENTION

The present invention relates generally to oil sands mining. More particularly, the present invention relates to a system and method of recovering heat and water from oil sands tailings using a vacuum flash process. The water recovered from this process can be used for steam generation in thermal recovery operations, extraction, utility purposes or other processes recognized by those skilled in the art requiring the use of water, steam or a combination thereof.

### BACKGROUND OF THE INVENTION

Oil sands are sand deposits which in addition to sand, contain clays, connate-water and bitumen. Depending on geographic location, bitumen may be recovered by mining or in-situ thermal methods. Examples of thermal in-situ recovery processes include but are not limited to steam-assisted gravity drainage (SAGD), cyclic steam stimulation (CSS), and various derivatives thereof, such as solvent-assisted SAGD (SA-SAGD), steam and gas push (SAGP), combined vapor and steam extraction (SAVEX), expanding solvent SAGD (ES-SAGD), constant steam drainage (CSD), and liquid addition to steam for enhancing recovery (LASER), as well as water flooding and steam flooding processes. Recovering the highly viscous bitumen from the oil sand poses numerous challenges, particularly since large quantities of heat and water are required to extract the bitumen. Further, most oil sand deposits are located in remote areas (such as, for example, the Fort McMurray area of northern Alberta, Canada), which can contribute to increased costs for transportation and processing, especially in harsh weather conditions.

Oil sand ore in a mining and extraction operation is typically processed using mechanical and chemical techniques to separate the bitumen from the sands. One of the most common extraction techniques is bitumen froth flotation. Hot water, air and process aides are added to the sands, resulting in the formation of an oil-rich froth that “floats” or rises to form a distinct hydrocarbon phase that can be separated from the aqueous layer. The waste ore (sand, clay, rock, other wastes) in combination with the spent processing water and reagents from the plant are known as tailings.

The properties of tailings are dependent on the ore body being mined, the grinding and processing circuits, the reagent properties and the thickening process prior to disposal. Tailings can be disposed of or stored in a variety of different methods. Unfortunately, the overall oil sands extraction process creates a large volume of waste requiring disposal. The extraction of one barrel of bitumen requires approximately 1 m³ of water. This water is stored in the tailings pond for years before the fines settle and some of the water recycled to the extraction process. The long settling times result in large tailings ponds.

An additional improvement to the overall oil sands extraction process is to enhance the total energy efficiency. In the current process, heat is added to water for use in the hydrotransport and conditioning of ore. Tailings that are generated via the current aqueous process are subsequently released to storage ponds at warm temperatures (20° C. to 90° C.), resulting in heat loss to the environment. The loss of energy is compensated by increasing the input of energy at the front end of the system. Thus, there has been a need to reduce input energy by recovering energy from the available waste streams.

Attempts to recover heat, water and other reagents used in the oil sands extraction process have been described in the prior art. U.S. Pat. Nos. 4,343,691, 4,561,965 and 4,240,897 are directed to heat and water vapor recovery from tailings for use in the extraction process using a humidification/dehumidification cycle. Brown et. al (U.S. Pat. No. 6,358,403 B1) describes a vacuum flash process for the purpose of recovering hydrocarbon solvents used in the extraction process. Heated tailings (˜80° C.) are subjected to a mild vacuum (˜35 kPaa) in order to flash and recover naphtha or paraffinic solvents. This particular scheme also included the addition of steam to enhance hydrocarbon recovery. However, there has been a lack of recent success in achieving effective energy and resource conservation methods, despite the progress made in oil sands bitumen extraction technology and the increasing global awareness of industrial environmental impacts.

In these and other methods, the amount of heat and water recovered from tailings by these methods is low (in the range of 0-5%). This has made very little impact on the oil sand bitumen extraction process. Thus, there exists a need to more efficiently and successfully recover residual heat and water for downstream uses. A more efficient recovery method of heat and water would also reduce costs and improve environmental performance. It is, therefore, desirable to provide a cost effective and environmentally sound process to recover residual heat and water from tailings, thereby reducing the amount of required energy during the oil sands extraction process.

### SUMMARY OF THE INVENTION

Generally, the present invention provides a method to recover heat and water from a warm slurry, such as warm tailings from an oil sands extraction mining operation. The method comprises providing the tailings to a vacuum vessel, removing, from the vacuum vessel, warm water vapor derived from the tailings, condensing the warm water vapor in a condenser to produce high quality water suitable as a feed source for steam generation, and recovering the water from the condenser. Cool water from any surface, subterranean or process-affected source destined for industrial use can be subsequently warmed with the heat from the condensation of the vapor for additional uses in the mining operation. Water of high quality suitable for use in steam generation can be obtained in the process. This can also be achieved using one or more flash vessels in series to produce and condense the vapor. Power can also be generated from the vapor using a turbine.

In a first aspect described herein, there is provided a method of recovering water of high quality suitable for steam generation (utilizing OTSG's, (once through steam generators) drum boiler or any other method known in the art) from a warm slurry (consisting of water, solids and hydrocarbons, for example), comprising the steps of: providing the slurry to a vacuum vessel; removing, from the vacuum vessel, warm water vapor derived from the slurry; condensing the warm water vapor in a condenser to produce liquid water; and recovering the high quality water from the condenser. Slurry remaining in the vacuum vessel after removal of the warm vapor is typically cooled and de-aerated, when compared to the added oil sands slurry.

The warm slurry feed for the process described in this invention can be any tailings stream, typically 20° C. to 90° C., generated during the oil sands extraction process. The liquid product recovered from the tailings is typically water, which when condensed is essentially pure. In the event that light hydrocarbons are present in the tailings stream, the recovered fluid may contain both high quality water and light hydrocarbon liquid.

Condensation of the vapor can be accomplished by cold water supplied to the condenser, such as from river or process-affected water sources. Alternately, cold water from any surface subterranean or industrial source or third party source may be used. The cold water absorbs the latent heat of condensation, which represents a significant percentage of the thermal energy which would be otherwise lost to the environment

Alternately, condensation of the water vapor can be achieved with any available heat sink. In certain embodiments, cold ambient air intended for combustion equipment could be used to condense the water vapor; the cold air condenses the water vapor and absorbs energy, therefore increasing the overall energy efficiency of the process. As an example, pipelined natural gas is typically throttled to a lower pressure upon entering an industrial site. This throttling causes a temperature drop according to the nature of the fuel and process conditions. The heat sink developed presents a cooling source that is independent of seasonal weather conditions. In the event where water is provided through a long pipeline, a near constant temperature is established, thus minimizing any seasonal temperature variations of the cold water supply or heat sink.

In another aspect of the present invention there is provided a method of recovering high quality water from a warm slurry (such as warm tailings, as described above) using a multistage flash process, comprising the steps of: providing the warm slurry to a first flash vessel, partially vaporizing the warm slurry in the first flash vessel to produce water vapor, condensing the water vapor in the first flash vessel via a cooling conduit (or possibly due to a rise in pressure) to form liquid, and recovering the high quality water for useful purposes.

Warm slurry not vaporized in the flash vessel can be processed in one or more additional flash vessels in series, if desired. Water vapor produced in the one or more additional flash vessels is condensed in a similar manner as in the first stage.

In a further aspect, the present invention provides a method of generating power from warm tailings obtained from an oil sands extraction process, comprising the steps of: providing the warm tailings to a vacuum flash vessel to produce water vapor, and providing the vapor to a turbine to generate power. In one embodiment, vapor from the turbine is provided to a condenser to condense the vapor, thereby producing cold water condensate.

In yet another aspect of the present invention there is provided a closed-cycle method of generating power from warm tailings obtained from an oil sands extraction process, comprising the steps of: providing the warm tailings to an evaporator containing a working fluid to produce working fluid vapor, and providing the working fluid vapor to a turbine to generate power. In one embodiment, the working fluid vapor is provided to a condenser to condense the working fluid for further use in the initial evaporation process. Rather than condensing tailings vapor, cold water is supplied to the condenser to condense the working fluid vapor, absorb the heat of condensation, and as a result increase the overall thermal efficiency of the mining operation.

The working fluid can be any suitable fluid, but is typically ammonia, ammonia-water mixtures or propylene.

In a further aspect, the present invention provides a system for recovering heat or water from an oil sands slurry comprising: a separation vessel for separating bitumen froth from the slurry; a vacuum vessel for removing warm vapor from the slurry; and a condenser for condensing the warm vapor to produce water.

In yet another aspect, the present invention provides a system for recovering heat and water from an oil sands slurry comprising: a separation vessel for separating bitumen froth from the slurry; a first flash vessel for receiving the slurry, wherein the first flash vessel vaporizes a portion of the slurry to produce a vapor; and a condenser for condensing the vapor to liquid water.

Any slurry not vaporized in the flash vessel is processed in one or more additional flash vessels in series.

In still another aspect, the present invention provides a system for generating power from an oil sands slurry, comprising: a flash chamber for vaporizing a portion of the slurry to produce vapor; and a turbine to generate power from the vapor. The system can further comprise a condenser to condense the vapor from the turbine, thereby producing a condensate.

In yet another aspect, the present invention provides a closed-cycle system for generating power from an oil sands slurry comprising: an evaporator containing a working fluid, wherein slurry added to the evaporator produces working fluid vapor; and a turbine from generating power from the working fluid vapor. The system can further comprise a condenser for condensing the working fluid vapor for further use in the evaporator.

Recovering both the water and the heat required to condense water vapor rather than allowing the low temperature heat to be lost to the atmosphere provides economic uplift by reducing makeup energy requirements for bitumen extraction, provides improved environmental performance through a reduction in greenhouse gas emissions and provides a reduction in fresh water use.

Methods in accordance with the present invention produce high quality water for bitumen extraction, boiler feedwater or other industrial purposes, thereby improving environmental performance by reducing freshwater requirements.

An added benefit to the vacuum process is the reduction in corrosion rates for pipe and equipment due to the inherent de-aerating of the tailings. Thus, non-metallic linings or coatings can be used in the piping and equipment used in the system or method of the present invention.

One advantage over direct heat recovery methods and systems known in the art (such as heat exchangers) is that no heat transfer surface contacts the tailings; the fouling and erosion/corrosion issues known to be present are virtually eliminated.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a scheme of one embodiment of the method or system of the present invention using a vacuum vessel.

FIG. 1A is one embodiment of the scheme of FIG. 1, but with an optional surge vessel.

FIG. 1B is one embodiment of the scheme of FIG. 1, but with the addition of a steam ejector.

FIG. 1C is one embodiment of the scheme of FIG. 1, but with the addition of a steam ejector upstream of a condenser.

FIG. 2 is a scheme of one embodiment of the method or system of the present invention using one or more flash vessels.

FIG. 3 is a scheme of one embodiment of the method or system of the present invention for generating power from warm tailings.

FIG. 4 is a closed-cycle scheme of one embodiment of the method or system of the present invention for generating power.

FIG. 5 illustrates data from an exemplary conversion of water to vapor using 3 initial temperatures.

Many aspects of the present invention can be better understood with reference to the above drawings. The elements and features shown in the drawings are not necessarily to scale, emphasis instead being placed upon clearly illustrating principles of exemplary embodiments of the present invention. Moreover, certain dimensions may be exaggerated to help visually convey such principles. In the drawings, same reference numerals designate like or corresponding, but not necessarily identical, elements throughout the several views.

### DETAILED DESCRIPTION

Generally, the present invention provides systems and methods for recovering heat, water or power from an oil sands slurry, but is applicable to any process utilizing or generating aqueous slurry or mine tailings.

In one aspect of the present invention there is provided a method of recovering high quality water from a warm oil sands slurry, comprising the steps of: providing the slurry to a vacuum vessel; removing, from the vacuum vessel, warm water vapor derived from the slurry; condensing the warm water vapor in a condenser to produce high quality water suitable as feed water for steam generation or the like; and recovering the water from the condenser.

In another aspect of the present invention there is provided a system for recovering heat or water from an oil sands slurry comprising: a separation vessel for separating bitumen froth from the slurry; a vacuum vessel for removing warm vapor from the slurry; and a condenser for condensing the warm vapor to produce high quality water, wherein the latent heat of condensation can be recovered.

As used herein, a “slurry” can refer to tailings obtained from an oil sands extraction process, but can be any solid-liquid mixture used or generated in mining or industrial operations from which heat and/or water can be recovered.

Typically, tailings from any source can be used. In accordance with exemplary embodiments of the present invention, tailings removed from oil sands processing methods known in the art can be used. The raw oil sands are heated and conditioned to extract bitumen from which hydrocarbon products are obtained. The tailings usually comprise residual hydrocarbons (or bitumen), sand, and water and are typically at elevated temperatures (20° C. to 90° C.) and thus contain residual heat. In most oil sands operations, tailings are discarded to open pits commonly referred to as “tailings ponds”. Residual heat is allowed to be released to the atmosphere, while process affected water is retained for potential future reuse with some loss to evaporation.

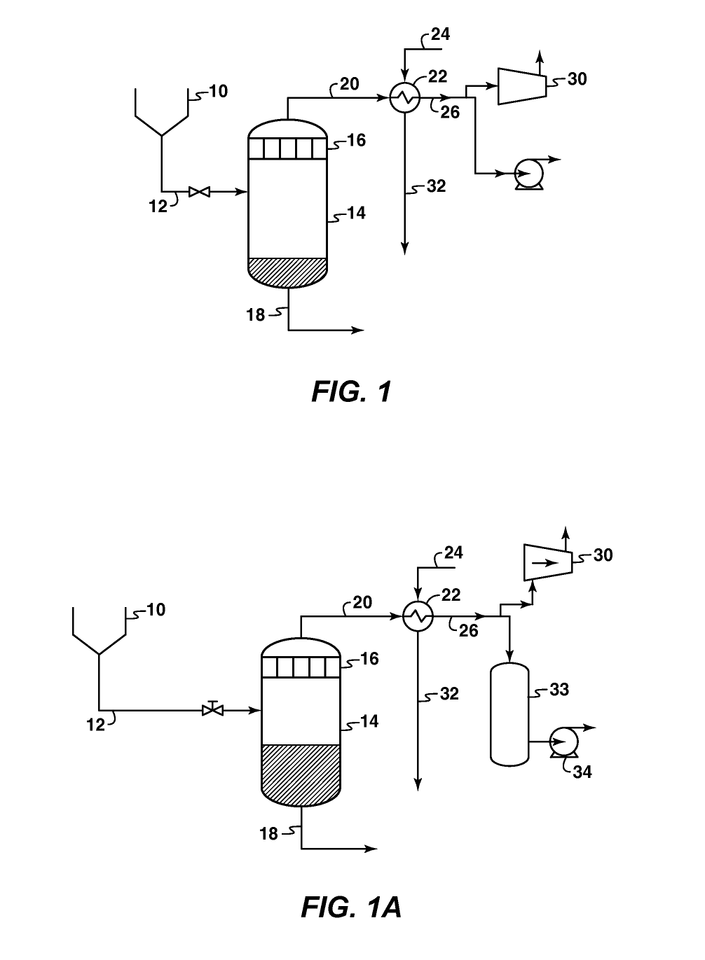

FIG. 1 illustrates an exemplary embodiment of a system and method in accordance with the present invention. Tailings (which can be coarse or sized through any separation means known in the art) are provided from any typical vessel that produces tailings (10), such those commonly used in an oil sands bitumen mining operation. The tailings enter a vacuum vessel (14) via a tailings conduit (12). The tailings are typically between 20° C. and 90° C., more typically between 35° C. and 45° C., but can be any temperature depending on the process conditions. The tailings can be derived directly from the crude oil sands (“primary tailings recovery”), from secondary recovery or any portion of the process that generates water and/or solids. The tailings may or may not contain solvent which may be added to the crude oil sands to assist in the bitumen extraction process.

The vacuum vessel (14) can be any appropriate chamber suitable for receiving tailings or related slurries. The vacuum is established by any means known in the art—a vacuum pump (30) is shown in FIG. 1. In the example shown, the vacuum vessel (14) contains a mist eliminator (16). Cooled solids and water at an appropriate temperature (defined as any temperature sufficiently greater than the available heat sink temperature that allows the full quantity of vapor to be condensed by the available heat sink flow rate; the rise in heat sink energy (mass×specific heat×temperature increase) will equal the energy given up by condensing and cooling the vapor) are sent to a tailings pond via a waste conduit or to further processing (18). Vapor which passes through the optional mist eliminator enters a vapor line (20). The vapor line (20) contains water vapor recovered from the tailings source (10) at a similar temperature to the cooled tailings (18). The vacuum is initially established with the vacuum pump (30). This device also removes non-condensable gasses, which are typically released to the atmosphere. The vapor then enters a condenser (22) in conjunction with the entry of a cold water heat sink into the condenser (22) via a water conduit (24). The cold water is then warmed via heat exchange, absorbing the latent heat of condensation of the water vapor and leaves the condenser (22) via a warm water conduit (32) at a temperature similar to the vapor temperature for use in other parts of the operation which require warm water (such as the bitumen extraction process in oil sands mining operations). The condensed vapor leaves the condenser (22) via a condensed water conduit (26) to pump (34). Any light hydrocarbons or solvents recovered in addition to the water can be readily separated from the recovered water and recombined at any point with the bitumen froth or used as a diluent. The water recovered from the process is considered clean water or of high quality for processes requiring it. These processes can include boiler feedwater for SAGD operations, or for other uses within the mine such as but not limited to utility steam, make up water, etc.

FIG. 1A shows a different embodiment of the system of FIG. 1. Optionally, a surge vessel (33) and a pump (34) can be added to pump the fresh water to the required locations in the operation, as would be typically known in the art.

FIG. 1B shows another embodiment of the system of FIG. 1. Steam conduit (13) supplies steam to a steam ejector (21) which has been added to the vapour line (20) from the vessel (14). This ejector creates or enhances the low pressure environment in the vessel, with the additional functionality of increasing the pressure (and, hence, temperature) of the vapour received at the condenser. The ejector then serves two purposes—the lower pressure achieved in the vacuum chamber creates a lower slurry temperature, allowing an increased recovery of water and heat, while the boost in vapour pressure/temperature allows the cold water to be heated to a higher level than otherwise possible. This can provide a greater temperature difference to the river water, and can remove any effect that seasonal temperature variations have on the process. As an example, if the cold water was 4° C., it could be heated to 13° C. by the vapor produced by flashing tailings to 1.5 kPa, with over 5% of the slurry recovered as high quality water. If during the summer, the cold water temperature rose to 20° C., a higher temperature flash would be required, resulting in both reduced high quality water recovery, (for instance approximately 3.5%) and reduced energy recovery. In contrast, a suitably designed system as described previously (such as described in, for example, Perry's Chemical Engineers Handbook, sixth Edition, 1984, ISBN0-07-04979-7, page 12-37) could cause the flash vessel to operate at approximately 1.5 kPa, and compress the vapors to approximately 7.6 kPa at 40.6° C. for condensation. This is an example of when the ejector is utilized. If one was to use a compressor and compress only the vapor the temperature at 7.6 kPa would be approximately 130° C. Hence, if mechanical compression was chosen, a much lower pressure ratio would be required to achieve a vapour temperature sufficient to achieve condensation.

The higher temperature of the vapor provides advantages by increasing the temperature difference between the vapor and cold water. This could result in a reduction in required surface area, and consequently a lower capital cost. An exemplary embodiment of the process, with the addition of a steam ejector, has features which are similar to steam-jet refrigeration cycles known in the art. There are, however, some important differences. One aspect of the present invention is to capture the heat and recover water for other useful purposes. A secondary compressor (30) can also be used in the system, to evacuate non-condensable gas to the atmosphere. While the exemplary embodiment in FIG. 1B indicates the use of steam ejectors, it could equally be possible to use one or more mechanical compressors to achieve similar results.

FIG. 1C shows a different embodiment of the system of FIG. 1, in accordance with one aspect of the present invention. Steam is derived from steam supply conduit (13). An additional steam ejector (35) is used in place of the compressor or vacuum pump (30) shown in FIG. 1B. This embodiment includes the use of a secondary condenser (39) to capture the energy used in compressing the non condensable gases; this is in addition to the primary steam ejector (21) and primary condenser (19) which is cooled by fluid stream (17).

The water vapor generated in the vacuum vessel (14) must be condensed to provide liquid. As the water required for the bitumen extraction process is available from surface, subterranean or process affected water sources at a cooler temperature than the vapor, this water can be used to provide a heat sink and condense the vapor and in turn is heated, reducing the energy requirements for the mining operation.

The heat required to condense the vapor is roughly the same as the heat removed from the tailings. For the typical conditions envisioned of 35° C. tailings flashed to 2 kPaa (kilo Pascal absolute), this is approximately 75 kJ per kg of water (˜4.18 kJ/kg-° C.). The energy can be absorbed by cold river water as an energy conservation method. As one example, cooling 150,000 m³ per day of water by 18° C. and concomitant heating of river or pond water can result in a financial savings of about $55,000 (Canadian Dollars)/day, at an energy cost of $5 (CAD)/GJ.

In another aspect of the present invention there is generally provided a method of recovering heat and water from a warm slurry using a flash process, comprising the steps of: providing the warm slurry to a first flash vessel; vaporizing the warm slurry in the first flash vessel to produce water vapor; condensing the vapor in the first flash vessel to remove water from the vapor; and recovering the water.

Further, the present invention provides a system for recovering heat or water from an oil sands slurry comprising: a separation vessel for separating bitumen froth from the slurry; a first flash vessel for receiving the slurry, wherein the first flash vessel vaporizes water from the slurry to produce water vapor; and a condenser for condensing the water from the vapor.

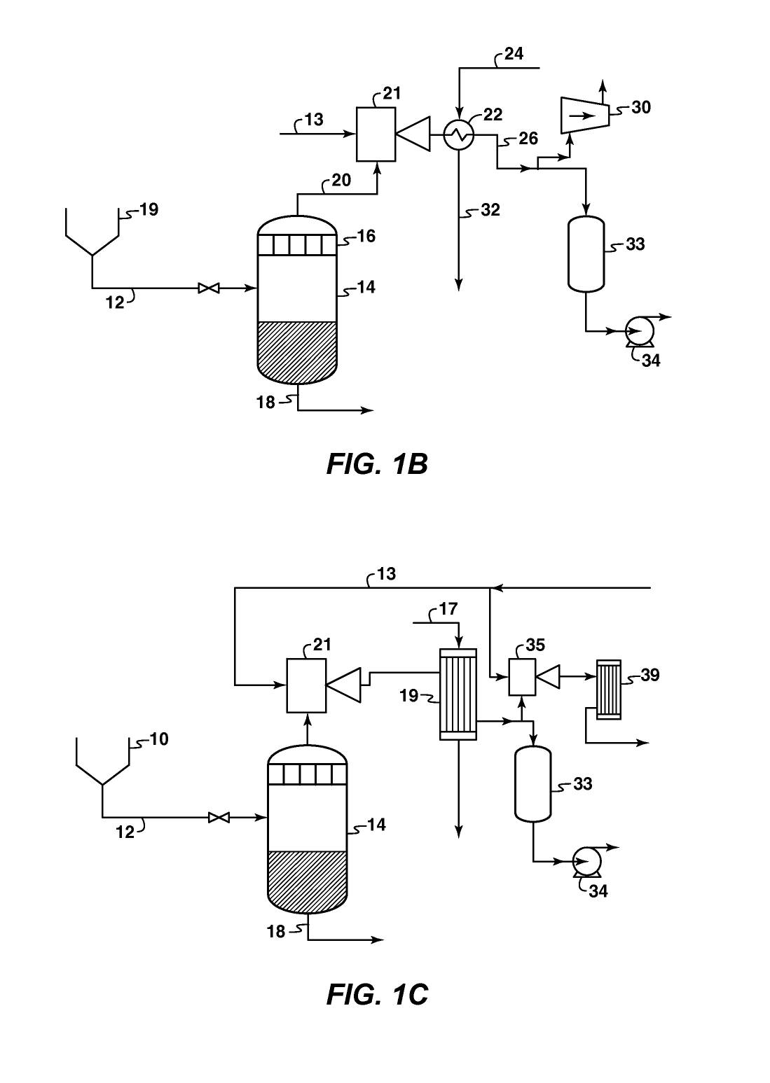

FIG. 2 shows an alternate embodiment of a method in accordance with the present invention. This scheme illustrates a multi-stage flash process. In this scheme, condensation occurs within a chamber (rather than outside the chamber, as illustrated in FIG. 1). As with the exemplary scheme outlined in FIG. 1, the tailings can be from any source in the overall extraction process, or a commingled stream of tailings. After any required removal of coarse solids through any separation device (40), tailings are sent via a tailings conduit (42) to one or more multi-stage flash vessels (44, 46, 48). Any number of flash vessels, in series or otherwise, can be used as required. As the tailings enter a first flash vessel (44), there is a drop in pressure which causes a portion of the water in the tailings to vaporize. The heat required to vaporize the water comes from the remaining liquid, whose temperature is allowed to drop via staged pressure reductions in subsequent vessels. The quantity of vapor produced is in relation to the inlet temperature and the level of vacuum pressure in the flash vessel (44). Vapor is condensed on the condenser tubes. Cold water is supplied to the condenser tubes via cooling water conduit (24). The heat of condensation is absorbed, and warm water is discharged via warm water conduit (51) for further use. Non condensable gas is removed through non-condensable gas conduit (55), and discharged by a steam ejector or other mechanical device (50) through conduit (57); in this case a steam ejector (50) is shown, using steam as the motive fluid through a steam supply conduit (53).

In the configuration shown in FIG. 2 the tubes are integral to the vessel. Liquid is collected in a separate chamber within the vessel, and is removed through conduit (56). Warm slurry entering additional flash vessels (46, 48) is further vaporized as outlined in the present invention. Water which condenses from vapor is removed from the flash vessels via a fresh water conduit (52, 54, 56) and can be commingled in a larger fresh water conduit (61) for further use or processing (such as to remove any solvent collected during the process). Non-condensable gas conduits (55a, 55b, 55c) lead into conduit (55). The condensate is essentially deionized water. This water is of near-distilled quality, and can be used for extraction, or boiler feedwater for an integrated mining/SAGD operation or any other application requiring water. Any water which has not vaporized exits the last of the one or more serial flash vessels via a waste water conduit (58) and can be disposed with the remaining solids and coarse tailings to a tailings pond via a waste conduit (60). Alternately, additional water from this stream may be recovered if desired by appropriate water recovery technologies selected to those skilled in the art (crystallizer, membranes, etc.).

Ideally, fresh water production from an open cycle scheme in accordance with at least one aspect of the present invention could amount to about 3% of the gross throughput, with tailings water cooled to roughly 17° C. from an initial 35° C. It is also recognized that higher water recoveries are achieved in circumstances when the tailings water exhibits a temperature greater than 35° C.

Optionally, a direct contact condenser (not shown) can be used if segregation of the condensed water is not required.

Adjusting the final flash pressure will also control the final temperature. A lower pressure provides additional vapor, and a greater net heat recovery from the tailings. If the heat sink temperature rises to where no condensing can occur due to seasonal variation, flashing to a higher pressure will still provided some heat recovery at a higher temperature. For 35° C. tailings, one could expect that the temperature could be reasonably adjusted between about 17° C. and about 29° C., for example.

Power and Fresh Water Generation

In another aspect of the present invention there is generally provided a method of generating power from warm tailings obtained from an oil sands extraction process, comprising the steps of: providing the warm tailings to a vacuum flash vessel to produce vapor; providing the vapor to a turbine to generate power, and a condenser to capture the water vapor as liquid for reuse.

Further, the present invention provides a system for generating power from an oil sands slurry, comprising: an vacuum flash vessel for vaporizing the slurry to produce vapor; and a turbine to generate power from the vapor. The system can further comprise a condenser for condensing the vapor.

Energy from heat sources has been generated in water desalination processes, such as in the Ocean Thermal Energy Conversion (OTEC) system. This system relies on the naturally occurring temperature difference between surface ocean water in the tropics and cold water from the depths to generate power and desalinated water. Many different schemes have been described in the art (such as U.S. Pat. No. 4,430,861, U.S. Pat. No. 5,582,691, U.S. Pat. No. 5,555,838, U.S. Pat. No. 4,430,861, and elsewhere). Unlike the present method, the schemes described in the art are intended to use temperature differences available in nature, and do not consider similar temperature heat sources from industrial processes. The low temperature differences imply very large low rates in order to produce useable power, and such flow rates are not common in industrial applications. In addition the application of this concept in an oil sands mining operation is significantly different in that a slurry is utilized rather than seawater. The density of the slurry may be as high as 1600 kg/m³ and the sensible heat contained in the solids will typically contribute to increased vapor production.

Due to the large volume of warm tailings water in bitumen mining operations, the heat can be used for generating power. Bitumen mines have flow rates and heat source/sink temperatures which are conducive to a favorable generation of power.

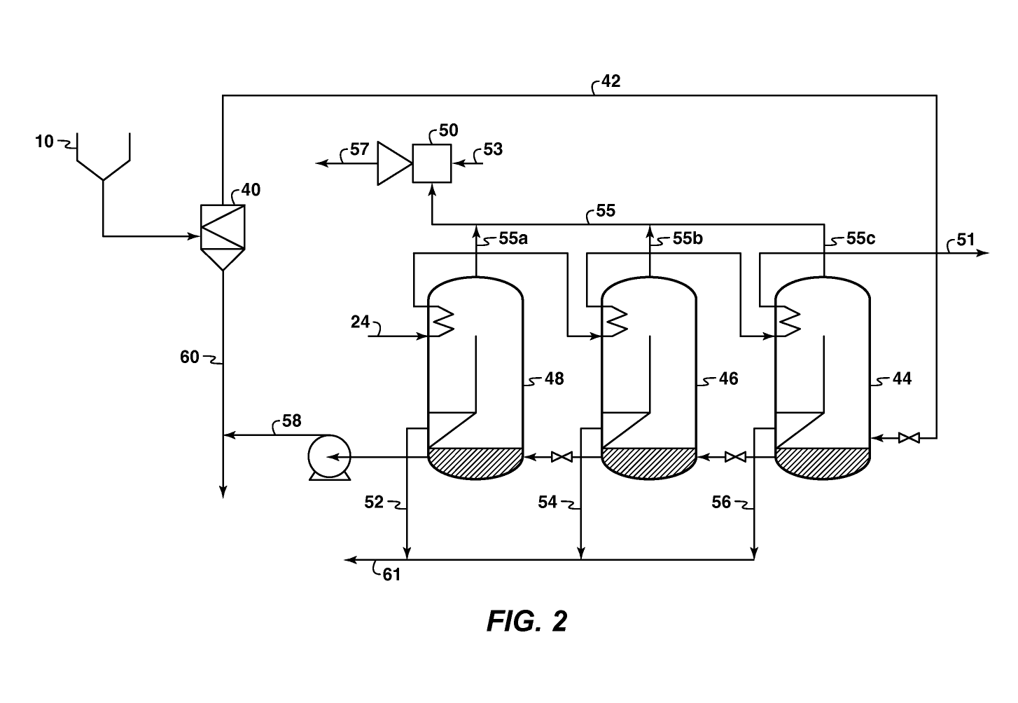

FIG. 3 shows an open-cycle power generating scheme in accordance with one aspect of the present invention. As with the embodiments outlined in FIGS. 1, 1A, 1B, 1C and 2, a heat source (such as from warm tailings) (70) enters a vacuum flash vessel (72). The initial vacuum is established by a suitable vacuum device (73 or 82) the vacuum is maintained by the removal of non-condensable gases (81) and the action of the condenser (76). Cooled fluids exit the flash chamber for disposal (through conduit 77) or furtherance to other processes. Water vapor from the vacuum flash vessel (72) then enters a turbine (turbogenerator; 74) to generate power. Power thus produced would be available for local use (in the oil sands mining operation), or for transmission through the electrical grid. Vapor leaving the turbine (74) enters a condenser (76) in conjunction with cool water derived from a nearby source (78), such as a river or pond or other heat sink, for example. The cold water (78) delivered through conduit (79) is warmed via heat transfer from the condensing vapor, and made available to other processes through conduit (77). Condensed water produced by this step is removed through a fresh water conduit (80) from the condenser for extraction or for other uses which would be contemplated by the skilled user as outlined when referring to the embodiments outlined in FIGS. 1, 1B, 1C and 2. These uses could include boiler feedwater for use with an integrated thermal operation (SAGD). As with those embodiments, the heat absorbed from the condensation process could reduce heating requirements for extraction purposes.

Typically, in the context of a 20° C. temperature difference, a flow rate of 4 m³/s is required to produce 1 MW of electricity. For most of the year, oil sands mining operations offer potentially available heat sinks of greater than 20° C. temperature difference. Any additional temperature gradient above 20° C. would, ideally, allow for additional electricity to be generated. For instance, mine tailings could be expected to be discharged at 35° C., and during winter months river (or pond) water would be less than 5° C., providing a net difference of 30° C.

As an alternative of the scheme exemplified in FIG. 3, a hybrid system for power generation and for heat and water recovery can be used, for using the recovered water for a typical SAGD operation. Such a scheme could provide as much as about 5000 m³ per day of fresh water and about 1 MW of electricity from the waste streams of a ‘nominal’ 300,000 bbl/d bitumen mine.

In yet another aspect of the present invention there is provided a closed-cycle method of generating power from warm tailings obtained from an oil sands extraction process, comprising the steps of: providing the warm tailings (donor fluid) to an evaporator containing a receptor fluid to produce receptor fluid vapor; and providing the receptor fluid vapor to a turbine to generate power.

Further, the present invention provides a closed-cycle system for generating power from an oil sands slurry comprising: an evaporator vessel containing a receptor fluid, wherein a donor fluid (for instance, slurry) supplied to the evaporator vessel produces receptor fluid vapor; a turbine from generating power from the receptor fluid vapor, and a condenser for condensing the receptor fluid vapor for further use in the evaporator vessel.

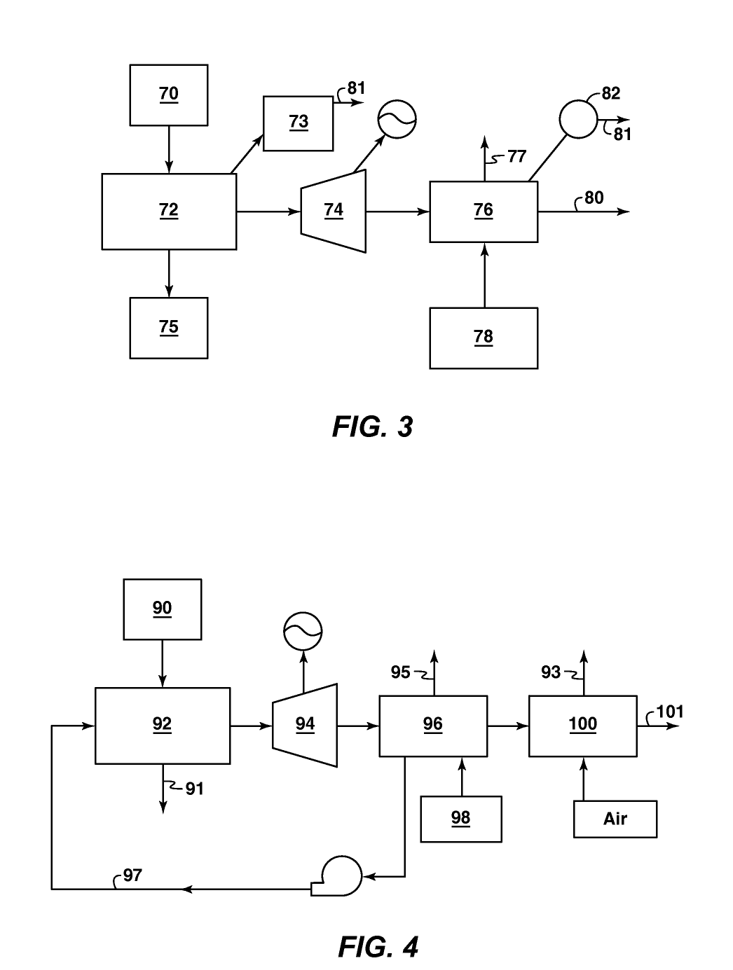

FIG. 4 illustrates a closed-cycle power generating scheme in accordance with one aspect of the present invention. The scheme is similar to the example shown in FIG. 3, except that the donor fluid (i.e. tailings) can heat and vaporize a receptor fluid such as ammonia, ammonia-water mixture, propylene or any suitable working fluid known in the art. In this exemplary scheme, warm donor fluid from a source (90) enters an evaporator vessel (92) and vaporizes the receptor fluid. Cooled donor fluid is released to other processes (conduit 91). The vapor is then used to operate a turbine (94) and generate power. The receptor vapor is then condensed in a condenser (96) in conjunction with water from a cold water source (98). Heat from condensing the working fluid would be used to preheat cold water for extraction purposes made available through conduit (95), rather than dumping the heat load to the atmosphere. Power could be maximized during winter operation by using colder ambient air in a secondary condenser (100) to condense the receptor vapor and release warmed air (93) or condensed receptor fluid (101), such that a greater pressure ratio across the turbine is established. A larger temperature drop would, typically, result in more power generation. Once condensed, the receptor fluid can be pumped back to the evaporator (92) via conduit (97) to be recycled for further vaporization with newly-introduced tailings.

The person of ordinary skill in the art would readily appreciate any source of warm water could easily be integrated into any of the schemes described herein, not only from thermal bitumen production.

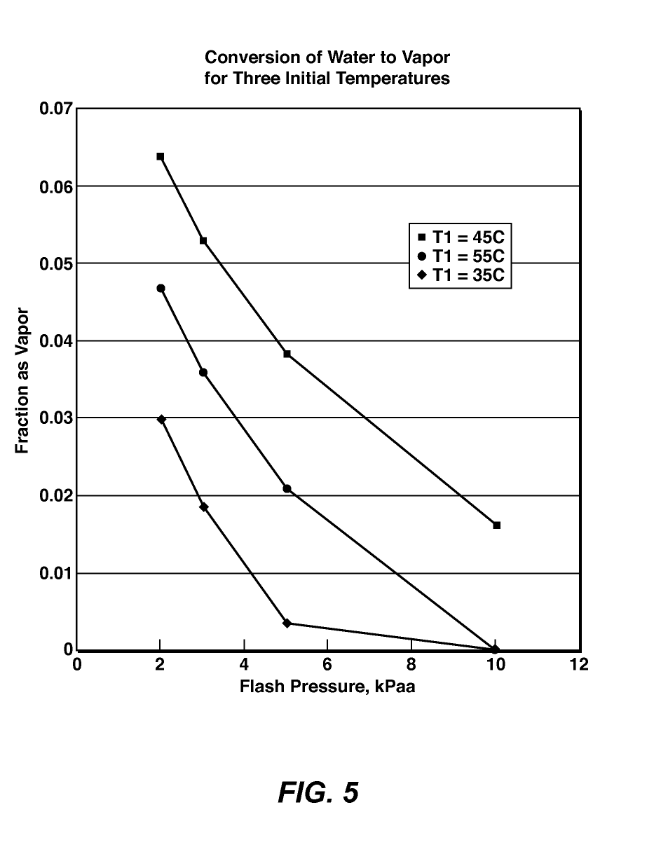

FIG. 5 shows an example of conversion of water to water vapor as a function of pressure, for three inlet slurry temperatures of 45° C., 55° C. and 35° C. at an initial inlet pressure of 99 kPaa.

Table 1 shows examples of the heat recovered from an exemplary heat/water recovery scheme in accordance with one aspect of the method of the present invention. The table shows results modeled from steam tables with no consideration of the sensible heat of solid particles.

TABLE 1
Heat recovery at varying flash pressures and flash temperatures

| | | | Conversion | Heat recovered |
|---|---|---|---|---|
| Slurry | | | of slurry | during |
| Initial | Flash | Flash | liquid | condensation |
| Temperature, | Pressure, | Temperature, | to Vapor, | kJ/kg |
| ° C. | kPa absolute | ° C. | wt % | condensate |
| 45 | 5 | 32.9 | 2.1 | 2423 |
| | 3 | 24.1 | 3.5 | 2444 |
| | 2 | 17.5 | 4.6 | 2459 |

The overall liquid recovery would provide a significant percentage of the water required for either utility purposes, or boiler feed water for a thermal recovery operation (SAGD). As an example, if the slurry volume was 150,000 m3/day, a 3.5% recovery would provide 5,250 m³/d of high quality water suitable for steam generation, while at the same time providing 12,800 GJ of recovered energy. The overall economic incentive of the process could result in the production of 1750 m³ bitumen (SOR 3:1) if the water was utilized for an in-situ thermal operation and as well as an energy cost savings exceeding $50,000/(Canadian Dollars)day (natural gas=$55 CAD/GJ).

The above-described embodiments of the present invention are intended to be examples only. Alterations, modifications and variations may be effected to the particular embodiments by those of skill in the art without departing from the scope of the invention, which is defined solely by the claims appended hereto.

1. A method for recovering heat and water from a warm slurry, comprising the steps of:
a) providing the slurry to a vacuum vessel;
b) removing, from the vacuum vessel, vapor derived from the slurry;
c) condensing the vapor in a condenser to produce water thereby recovering the latent heat; and
d) recovering the water from the condenser.

2. The method of claim 1, wherein after condensation, slurry remaining in the condenser is in a cooled, de-aerated form.

3. The method of claim 2, wherein the cooled, de-aerated slurry is less corrosive than the warm slurry.

4. The method of claim 1, performed with equipment having non-metallic linings or coatings.

5. The method of claim 1, wherein the warm slurry is warm tailings obtained from oil sands extraction.

6. The method of claim 1, wherein the recovered water is high quality water suitable for the generation of steam.

7. The method of claim 1, wherein the recovered water is distilled or deionized.

8. The method of claim 6 wherein the recovered water is used to generate steam for thermal in-situ bitumen recovery operations.

9. The method of claim 8 where the thermal in-situ bitumen recovery operations are SAGD, SA-SAGD, cyclic steam stimulation (CSS), solvent-assisted SAGD (SA-SAGD), steam and gas push (SAGP), combined vapor and steam extraction (SAVEX), expanding solvent SAGD (ES-SAGD), constant steam drainage (CSD), and liquid addition to steam for enhancing recovery (LASER), water flooding, steam flooding processes, or a derivative thereof.

10. The method of claim 1, wherein in step c), the condensing step is provided by cold water supplied to the condenser.

11. The method of claim 1, wherein in step c), the condensing step is provided by a gas.

12. The method of claim 11, wherein the gas is air, nitrogen or ammonia.

13. The method of claim 11 the condensing step is provided by natural gas.

14. The method of claim 10, wherein the cold water is heated by the vapor.

15. The method of claim 11, wherein the gas is heated by the vapor.

16. The method of claim 13, wherein the natural gas is heated by the vapor.

17. The method of claim 10, wherein the cold water is derived from surface, subterranean or process-affected water sources.

18. The method of claim 1, wherein condensable hydrocarbons from a waste stream are recovered.

19. The method of claim 18, wherein the condensable hydrocarbons have been added to the slurry.

20. The method of claim 1, wherein the slurry has a temperature of about 20° C. to about 90° C.

21. The method of claim 1, wherein the slurry has a temperature of about 35° C. to about 45° C.

22. A method of recovering water from a warm slurry using a multi-stage flash process, comprising the steps of:
a) providing the warm slurry to a first flash vessel;
b) vaporizing a portion of the warm slurry in the first flash vessel to produce vapor;
c) condensing the vapor in the first flash vessel to remove the water from the vapor; and
d) recovering the water.

23. The method of claim 22, wherein the warm slurry is warm tailings from oil sands extraction.

24. The method of claim 22, wherein warm slurry not vaporized in the flash vessel is processed in one or more additional flash vessels in series.

25. The method of claim 24, wherein warm slurry not vaporized in the flash vessels is sent to a pond for storage, to recycling to the process, or to further water recovery processing.

26. The method of claim 25, wherein the further water recovery processing is carried out using an evaporator, crystallizer or a membrane.

27. The method of claim 22, wherein the water is of high quality and used for boiler feed water for thermal oil recovery operations, oil sands mining operations or other processes requiring high quality water.

28. The method of claim 24, wherein vapor produced in the one or more additional flash vessels is condensed for recovery.

29. The method of claim 22, wherein the step of vaporizing is performed at a flash temperature of about 7° C. to about 33° C.

30. A method of generating power from warm tailings obtained from an oil sands extraction process, comprising the steps of:
a) providing the warm tailings to a flash chamber to produce vapor; and
b) providing the vapor to a turbine to generate power.

31. The method of claim 30, further comprising the step of:
c) providing vapor from the turbine to a condenser to condense the vapor, thereby recovering high-quality water condensate.

32. The method of claim 31, wherein cold water is supplied to the condenser to condense the vapor.

33. The method of claim 32, wherein the cold water is derived from surface, subterranean or process-affected water sources.

34. The method of claim 30, wherein the flash vessel has a flash temperature of about 7° C. to about 35° C.

35. A closed-cycle method of generating power from warm tailings obtained from a oil sands extraction process, comprising the steps of:
a) providing the warm tailings as a donor fluid to an evaporator vessel containing a receptor fluid to produce receptor fluid vapor; and
b) providing the receptor fluid vapor to a turbine to generate power.

36. The method of claim 35, further comprising the step of
c) providing the receptor fluid vapor to a condenser to condense the receptor fluid for further use in step a).

37. The method of claim 36, wherein cold water is supplied to the condenser to condense the receptor fluid vapor.

38. The method of claim 37, wherein the cold water is derived from a surface, a subterranean or a process-affected water source.

39. The method of claim 35, wherein the receptor fluid is ammonia, an ammonia-water mixture, propane, or propylene.

40. The method of claim 35, wherein the evaporator has a vapor outlet temperature of about 20° C. to about 90° C.

41. A system for recovering heat or water from a oil sands slurry comprising:
a separation vessel for separating bitumen froth from the slurry;
a vacuum vessel for removing warm vapor from the slurry; and
a condenser for condensing the warm vapor to produce water.

42. The system of claim 41, wherein slurry remaining in the vacuum vessel after removal of the warm vapor, is cooled and de-aerated.

43. The system of claim 42, wherein the cooled and de-aerated slurry is less corrosive than the oil sands slurry entering the system.

44. The system of claim 41, wherein equipment used in the system has non-metallic linings or coatings.

45. The system of claim 41, wherein the oil sands slurry is warm tailings.

46. The system of claim 41, wherein the water is high quality water suitable for use as boiler feedwater for steam generation or for the extraction process.

47. The system of claim 41, wherein cold water is added to the condenser for condensing water from the warm vapor.

48. The system of claim 47, wherein the warm vapor heats the cold water.

49. The system of claim 47, wherein the cold water is derived from surface, subterranean or process affected water.

50. The system of claim 41, wherein the oil sands slurry has a temperature of about 20° C. to about 90° C.

51. The system of claim 41, wherein the slurry has a temperature of about 35° C. to about 45° C.

52. A system for recovering heat or water from an oil sands slurry comprising:
a separation vessel for separating bitumen froth from the slurry;
a first flash vessel for receiving the slurry, wherein the first flash vessel vaporizes the slurry to produce a vapor; and
a condenser for condensing the vapor to liquid.

53. The system of claim 52, wherein the slurry is warm tailings.

54. The system of claim 52, wherein any slurry not vaporized in the flash vessel is processed in one or more additional flash vessels in series.

55. The system of claim 54, wherein the condenser is within the first flash vessel or the one or more additional flash vessels.

56. The system of claim 54, wherein the first flash vessel or one or more additional flash vessels have a flash temperatures of about 7° C. to about 33° C.

57. A system for generating power from an oil sands slurry, comprising:
a vacuum flash vessel for vaporizing the slurry to produce vapor; and
a turbine to generate power from the vapor.

58. The system of claim 57 further comprising a condenser to condense the vapor from the turbine, thereby producing a condensate.

59. The system of claim 57, wherein the slurry is warm tailings.

60. The system of claim 58, wherein cold water is supplied to the condenser to condense the vapor.

61. The system of claim 60, wherein the cold water is derived from surface, subsurface or process affected water.

62. The system of claim 57, wherein the flash vessel has a flash temperature of about 7° C. to about 33° C.

63. A closed-cycle system for generating power from an oil sands slurry comprising:
an evaporator vessel containing a receptor fluid, wherein the slurry added to the evaporator vessel as a donor fluid produces receptor fluid vapor;
a turbine from generating power from the receptor fluid vapor; and
a condenser for condensing the receptor fluid vapor for further use in the vacuum flash vessel.

64. The closed-cycle system of claim 63, wherein the slurry is warm tailings.

65. The closed-cycle system of claim 63, wherein cold water is supplied to the condenser to condense the receptor fluid vapor.

66. The closed-cycle system of claim 65, wherein the cold water is derived from a surface, subsurface or process affected water source.

67. The closed-cycle system of claim 63, wherein the receptor fluid is ammonia, an ammonia-water mixture, propane or propylene.

68. The closed-cycle system of claim 63, wherein the evaporator has an evaporation temperature of about 20° C. to about 90° C.
